(19) United States
(12) Patent Application Publication
(10) Pub. No.: US 2007/0155397 A1
(43) Pub. Date: Jul. 5, 2007

(54) Apparatus and method for measuring amount of user traffic in wireless communication system

(75) Inventors: Chul Park, Daejeon-city (KR); Chul-Sik Yoon, Daejeon-city (KR)

Correspondence Address: THE FARRELL LAW FIRM, P.C., 333 EARLE OVINGTON BOULEVARD, SUITE 701, UNIONDALE, NY, 11553, US

(73) Assignees: SAMSUNG ELECTRONICS CO., LTD., Suwon-si (KR); Electronics and Telecommunications Research Institute, Yuseong-gu (KR); KT Corporation, Seongnam-city (KR); SK TELECOM CO., LTD, Seoul (KR); HANARO TELECOM., INC., Seoul (KR)

(21) Appl. No.: 11/636,811

(22) Filed: Dec. 11, 2006

(30) Foreign Application Priority Data
Dec. 9, 2005 (KR) 10-2005-0120766

(51) Int. Cl. H04Q 7/20

(52) U.S. Cl. 455/453; 370/395.52

(57) ABSTRACT

The present invention relates to a method and device for measuring an amount of user traffic in a mobile communication system. Without changing a configuration of the mobile communication system, the amount of traffic used in a subscriber station for each subscriber may be measured and analyzed by using information allocated for each basic connection identifier (CID) of the subscriber station based on a downlink MAP information element (IE) and an uplink MAP IE that are included in a downlink broadcasted from a base station.

### PRIORITY

This application claims priority under 35 U.S.C. §119 to a Korean application filed in the Korean Intellectual Property office on Dec. 9, 2005 and allocated Serial No. 10-2005-0120766, the contents of which are incorporated herein by reference.

### BACKGROUND OF THE INVENTION

(a) Field of the Invention

The present invention relates to an apparatus and method for measuring an amount of user traffic in a mobile communication system. More particularly, the present invention relates to a method for measuring and analyzing the amount of traffic of subscribers using a subscriber station to receive a service.

(b) Description of the Related Art

A portable Internet system, which is one of mobile communication systems, is defined by the IEEE Std 802.16-2004, IEEE Std 802.16e-2005, and IEEE Std 802.16-2004/Cor1-2005 standards. In the portable Internet system, since a subscriber, a base station, and a router are defined to be compatible with an existing public Internet protocol (IP) network and the terminal may have mobility, an IP-based network service may be provided through the terminal having the mobility while on the move.

Generally, monitoring systems and methods for measuring and analyzing traffic of subscribers in the mobile communication system have been widely disclosed, but a method for measuring and analyzing the amount of traffic of subscribers in the portable Internet system has not yet been published.

In addition, to measure and analyze the traffic capacity of the subscriber station in the portable Internet system, it is required to monitor the traffic based on a standard of the portable Internet system. Accordingly, it is difficult to apply the monitoring system and method based on the conventional mobile communication system standard to the portable Internet system.

### SUMMARY OF THE INVENTION

The present invention has been made in an effort to provide a method and device for efficiently measuring and analyzing an amount of traffic used by subscribers to receive a service in a mobile communication system using a device with the type of simplified subscriber station.

In an exemplary method for measuring an amount of traffic of a subscriber station within an area of a base station including a traffic measuring device in a mobile communication system according to an embodiment of the present invention, downlink resource size information for each basic connection identifier (CID) is measured based on downlink MAP (DL-MAP) information elements of a transmission frame broadcasted from the base station, uplink resource size information for each basic CID is measured based on uplink MAP (UL-MAP) information elements of the transmission frame broadcasted from the base station, and the amount of traffic used by the subscriber station having the predetermined basic CID is measured based on the downlink and uplink resource size information.

An exemplary device for measuring an amount of traffic of a subscriber station within an area of a base station in a mobile communication system according to an embodiment of the present invention includes a MAP information element storage unit, a downlink/uplink basic connection identifier (CID) information storage unit, a downlink/uplink basic CID and MAC address mapping/storing unit, a ranging response message determining/receiving unit, and a traffic calculator. The MAP information element storage unit receives a downlink broadcasted from the base station and stores information elements for downlink and uplink MAPs that are broadcast information included in the downlink. The downlink/uplink basic CID information storage unit stores predetermined basic CID information based on the stored downlink and uplink MAP information elements, and the basic CID information includes the number of downlink/uplink slots allocated to a basic CID and adaptive modulation and coding (AMC) levels of the downlink/uplink slots. The downlink/uplink basic CID and MAC address mapping/storing unit maps and stores the basic CID information and a medium access control (MAC) address of the subscriber station that is extracted based on a ranging response message broadcasted through burst information included in the downlink broadcasted from the base station. The ranging response message determining/receiving unit determines whether there is an initial ranging response message transmitted from the base station, and receives the initial ranging response message when there is an initial ranging response message transmitted from the base station.

### BRIEF DESCRIPTION OF THE DRAWINGS

FIG. 1 shows a diagram of a network configuration of a portable Internet system according to an exemplary embodiment of the present invention.

FIG. 2 shows a transmission frame configuration diagram of the portable Internet system according to the exemplary embodiment of the present invention.

FIG. 3 shows a detailed configuration diagram of a MAP information element (IE) in a transmission frame according to the exemplary embodiment of the present invention.

FIG. 4 shows a configuration diagram of a traffic measuring device according to the exemplary embodiment of the present invention.

FIG. 5 shows a flowchart representing a method for measuring traffic according to the exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

In addition, unless explicitly described to the contrary, the word “comprise” and variations such as “comprises” or “comprising” will be understood to imply the inclusion of stated elements but not the exclusion of any other elements.

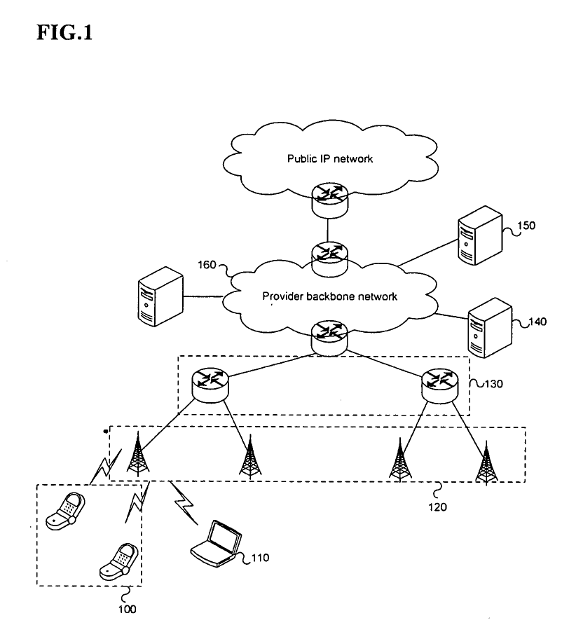

FIG. 1 shows a diagram of a network configuration of a portable Internet system according to an exemplary embodiment of the present invention.

In FIG. 1, according to the exemplary embodiment of the present invention, the portable Internet system among mobile communication systems is exemplified. The network configuration of the portable Internet system includes a portable subscriber station (PSS) 100, a radio access station 120 (RAS) 120 for controlling access and service of the PSS 100, and an access control router (ACR) 130 for performing a packet access routing function and an external agent function of a mobile Internet protocol, and it is connected to an IP network 160 to provide an Internet service.

A traffic measuring device 110 uses the PSS 100 to measure and analyze an amount of traffic that is used by a subscriber to receive and use a service in one RAS 120. Here, it is not required to additionally provide a device to the traffic measuring device 110, and the PSS 100 may be used to measure and analyze the traffic.

In addition, the IP network includes an authentication, authorization, and accounting (AAA) 140 and a home agent (HA) 150, which are generally well known, and therefore detailed descriptions thereof will be omitted.

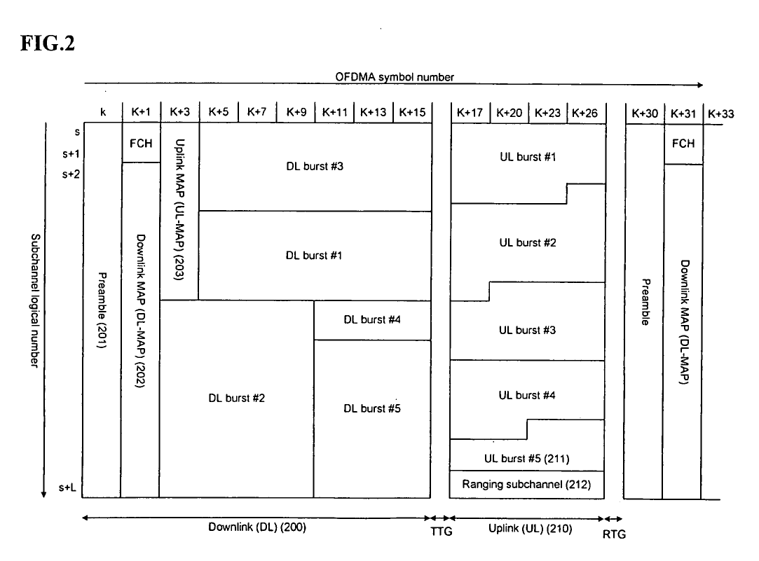

FIG. 2 shows a transmission frame configuration diagram of the portable Internet system according to the exemplary embodiment of the present invention.

As shown in FIG. 2, a transmission frame includes a downlink frame 200 transmitted from the RAS 120 to the PSS 100 and an uplink frame 210 transmitted from the PSS 100 to the RAS 120. A vertical axis of the frame shows subchannels including orthogonal frequencies, and a horizontal axis is a time-divided time axis.

The downlink frame 200 includes a preamble 201, a downlink MAP 202, an uplink MAP 203, and a plurality of downlink bursts 204. Channels and resources of the downlink bursts 204 are not classified for each user, but they are classified for each transmission level having the same modulation method and the same channel skill. Accordingly, the downlink MAP 202 uses a connection identifier (CID) to identify the PSS 100 of a user, and uses offset information, modulation method information, and coding information that correspond to the identified PSS 100 to allocate resources for the PSS 100.

Accordingly, the downlink MAP 202 and the uplink MAP 203 are used to transmit a location of a burst allocated to each user, and information commonly broadcasted to the PSSs 100 of all the users in the transmission frame. Therefore, the downlink MAP 202 has broadcast channel characteristics, and requires high robustness.

In addition, the uplink frame 210 is transmitted for each user, and a plurality of uplink bursts 211 have information for each user. The uplink frame 210 includes a ranging subchannel 212 for the PSS 100 to periodically transmit a state of the PSS 100 to the RAS 120.

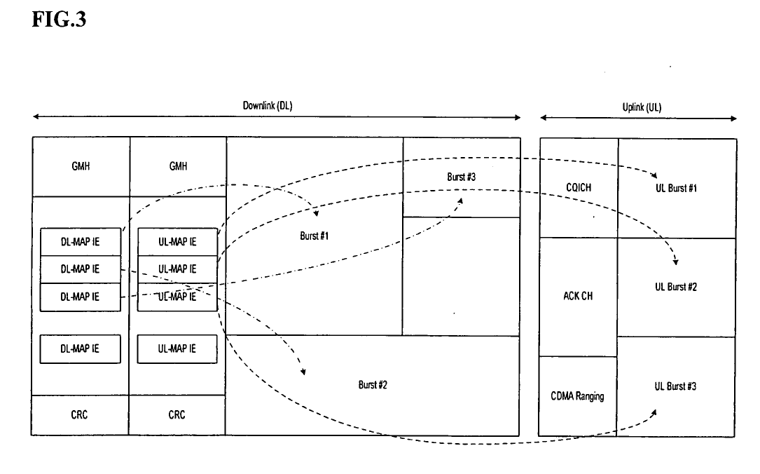

As shown in FIG. 2, the uplink and downlink MAPs (hereinafter, referred to as a “MAP”, for convenience of descriptions) and the information commonly broadcasted to the PSSs 100 by the burst among constituent elements of the transmission frame of the portable Internet system are used to measure the amount of traffic used by the respective PSSs 100 in one RAS 120, according to the exemplary embodiment of the present invention. A configuration of MAP information in the transmission frame will be described with reference to FIG. 3.

FIG. 3 shows a detailed configuration diagram of a MAP information element (IE) in the transmission frame according to the exemplary embodiment of the present invention.

As shown in FIG. 3, the MAP includes a downlink MAP 202, an uplink MAP 203, and a plurality of MAP IEs.

The respective PSSs 100 receive the MAP in the downlink frame 200 of the transmission frame shown in FIG. 2, detects broadcast information and information of the burst allocated to the PSS 100, and perform uplink/downlink communication based on the information. In a standard of the portable Internet system, an initial ranging process is defined so that the PSS 100 initially accesses a network through the RAS 120, and it is defined that a ranging request/ranging response (RNG-REQ/RNG-RSP) message is transmitted between the PSS 100 and the RAS 120.

The PSS 100 transmits the RNG-REQ message to the RAS 120 for the initial ranging, and the RAS 120 transmits the RNG-RSP message in response to the RNG-REQ message. The RNG-REQ message transmitted to the RAS 120 from the PSS 100 used by a subscriber includes a medium access control (MAC) address of the PSS 100. The RNG-REQ message and RNG-RSP message are transmitted for periodical ranging in addition to the initial ranging process.

When transmitting the RNG-RSP message to the predetermined PSS 100 in response to the RNG-REQ message, the RAS 120 adds the MAC address of the PSS 100 to the RNG-RSP message. In this case, the MAC address is an address added to the RNG-RSP message by the PSS 100 when the PSS 100 transmits the RNG-REQ message to the RAS 120. The RAS 120 adds a basic CID defined to separately manage the PSS 100 in the RNG-RSP message, and transmits it.

In this case, the burst including the RNG-RSP message transmitted by the RAS 120 is transmitted by using a predetermined modulation method that is previously agreed with the PSSs 100 within an area of the RAS 120. Therefore, the PSSs in the area of the RAS 120 may demodulate the RNG-RSP message.

Here, the RNG-RSP message has broadcast information characteristics transmitted to the PSSs 100 in the RAS 120, which have already been defined in the standard. When compiling all the RNG-RSP messages transmitted from the RAS 120 to the PSS 100, the MAC address of the PSSs 100 accessed to the RAS 120 and the basic CID transmitted from the corresponding RAS 120 the PSSs 100 accessed to the RAS 120 may be detected.

Accordingly, since the traffic measuring device 110 according to the exemplary embodiment of the present invention receives the RNG-RSP messages from the RAS 120, the MAC address of the PSSs 100 accessed to the RAS 120 and the basic CID provided to the PSSs 100 may be detected. Therefore, the PSSs 100 accessed to the RAS 120 may be separately managed.

In addition, characteristics of the MAP and the MAP IE forming the MAP are defined as follows.

The MAP is broadcasted information, and it may be received by the PSSs 100 within the RAS 120.

The MAP IE in the MAP includes resource allocation information for the basic CID. Here, the resource allocation information includes the number of slots and adaptive modulation and coding (AMC) level information.

When resource allocation is performed, the RAS 120 allows the PSS 100 to use resources of the RAS 120 so that uplink or downlink communication may be performed between the various PSSs 100 and one RAS 120.

In addition, the slot expressed by a product of the subchannel and symbol shown in FIG. 2 is a basic unit of the resources. A size of the bandwidth used for uplink/downlink transmission between the RAS 120 and the PSS 100 is expressed by using the slot.

The AMC level is information indicating the modulation method and the channel coding method used to transmit the slot used to perform the uplink or downlink transmission, and a data rate indicating an amount of information transmitted by a predetermined number of slots may be detected by the AMC level. Accordingly, when receiving the MAP and analyzing the AMC level and the number of slots allocated to the PSS 100 that is accessed to the RAS 120 and has the basic CID, the traffic measuring device 110 may detect uplink and downlink resources allocated to the PSS 100 having the basic CID. In this case, sizes of uplink and downlink resources are the same as the amount of traffic used in one transmission frame by the PSS 100 using the basic CID in the RAS 120.

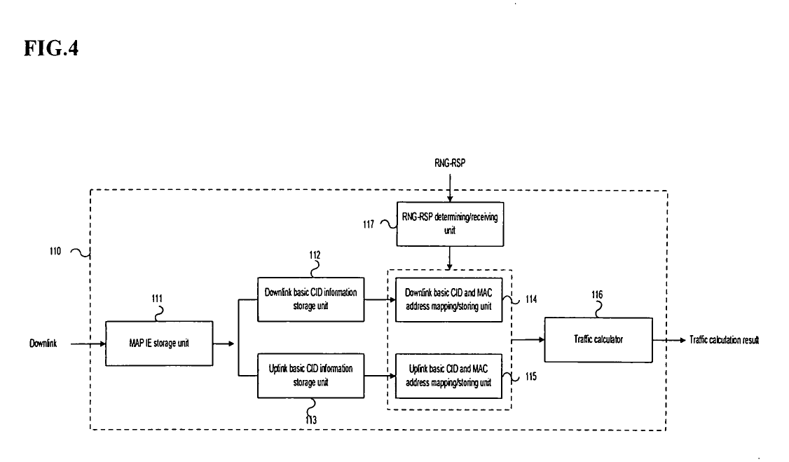

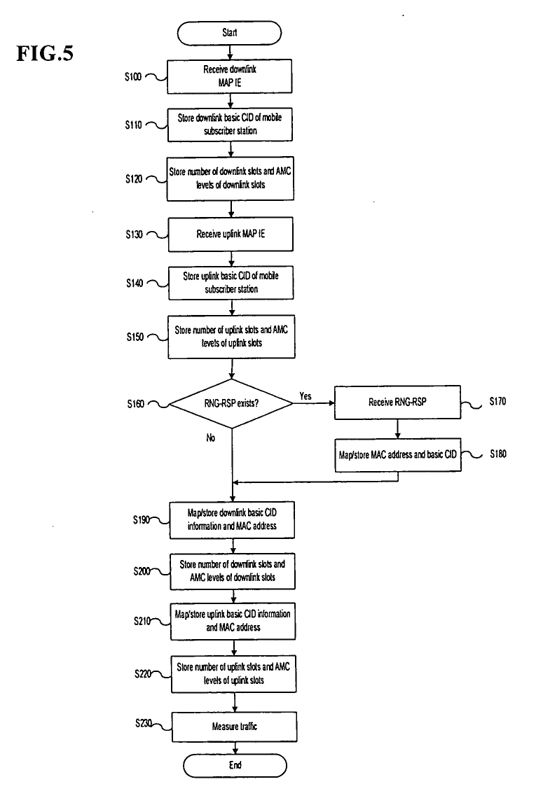

A device and method for analyzing the amount of traffic estimated by the size of the uplink and downlink resources allocated to the PSS 100 by the MAP and the MAP IE will be described with reference to FIG. 4 and FIG. 5.

FIG. 4 shows a configuration diagram of the traffic measuring device according to the exemplary embodiment of the present invention.

As shown in FIG. 4, the traffic measuring device 110 includes a MAP IE storage unit 111, a downlink basic CID information storage unit 112, an uplink basic CID information storage unit 113, a downlink basic CID and MAC address mapping/storing unit 114, an uplink basic CID and MAC address mapping/storing unit 115, a traffic calculator 116, and a RNG-RSP determining/receiving unit 117.

The MAP IE storage unit 111 stores an information element of the downlink MAP 202 and an information element of the uplink MAP 203 in the downlink frame 200 broadcasted from the RAS 120. The uplink and downlink MAP information elements include the basic CID of the PSS 100.

The downlink basic CID information storage unit 112 includes the number of slots and the slot AMC level allocated to the basic CID for the downlink among the basic CIDs of the PSS 100 in the downlink MAP information element stored in the downlink/uplink MAP IE storage unit 111.

The uplink basic CID information storage unit 113 includes the number of slots and the slot AMC level allocated to the basic CID for the uplink among the basic CIDs of the PSS 100 in the downlink MAP information element stored in the downlink/uplink MAP IE storage unit 111.

Hereinafter, for better understanding and ease of description, the downlink basic CID information storage unit 112 and the uplink basic CID information storage unit 113 will be referred to as a “downlink/uplink basic CID information storage unit”.

The downlink basic CID and MAC address mapping/storing unit 114 maps and stores the downlink basic CID information and the MAC address stored in the downlink basic CID information storage unit 112, and the uplink basic CID and MAC address mapping/storing unit 115 maps and stores the uplink basic CID information and the MAC address stored in the uplink basic CID information storage unit 113.

Hereinafter, for better understanding and ease of description, the downlink basic CID and MAC address mapping/storing unit 114 and the uplink basic CID and MAC address mapping/storing unit 115 will be referred to as a “downlink/uplink basic CID and MAC address mapping/storing unit”. Here, the MAC address is a MAC address of the PSS 100 in the burst broadcast message broadcasted by the RAS 120. In this case, the burst broadcasting message is included in the burst of the downlink frame broadcasted from the RAS 120.

The RNG-RSP determining/receiving unit 117 determines whether there is an RNG-RSP message transmitted from the RAS 120 to the PSS 100, and receives when there is a ranging response message. The RNG-RSP message includes the MAC address and CID of the PSS 100, and the MAC address is input to the downlink/uplink basic CID and MAC address mapping/storing unit and is mapped to the basic CID information.

The traffic calculator 116 calculates the amount of the PSS 100 based on the information stored in the downlink/uplink basic CID and MAC address mapping/storing unit.

A method for measuring the traffic of the PSS 100 by using the traffic measuring device 110 will be described with reference to FIG. 5.

FIG. 5 shows a flowchart representing the method for measuring the traffic according to the exemplary embodiment of the present invention.

As shown in FIG. 5, the traffic measuring device 110 receives the downlink frame 200 broadcasted from the RAS 120, and receives the downlink MAP IE in the downlink MAP transmitted through the downlink frame 200 in step S100. When the traffic measuring device 110 receives the MAP IE in step S100, the RAS 120 stores each basic CID information allocated to each PSS 100 accessed to the RAS 120 in step S110, and in this case, the Basic CID information is the downlink basic CID of the PSS 100.

The RAS 120 storing the basic CID information stores the number of downlink slots allocated to the corresponding basic CID and the AMC level of the downlink slot allocated to the corresponding basic CID in step S120. The RAS 120 may detect the size of the downlink resources allocated for each basic CID through the number of downlink slots and the AMC level information.

After detecting the size of the downlink resource, the traffic measuring device 110 receives the uplink MAP IE in the downlink frame 200 from the RAS 120 in step S130. When the PSS 100 receives the uplink MAP IE in step S130, the traffic measuring device 110 stores the basic CID of each PSS 100 in step S140 in a like manner of the downlink MAP IE. Subsequently, the traffic measuring device 110 stores the number of uplink slots allocated to the basic CID and the AMC level of the uplink slot allocated to the corresponding basic CID in step S150. Accordingly, the traffic measuring device 110 may detect the size of the uplink/downlink resources allocated to the PSS 100 having the basic CID.

When the size of the uplink/downlink resources is determined, the traffic measuring device 110 determines in step S160 whether there is a RNG-RSP message among messages broadcasted from the RAS 120. The RNG-RSP message includes the MAC address and the basic CID information indicating the PSS 100 newly accessed to the RAS 120.

Since the resources are allocated by the RAS 120 based on the basic CID and the uplink/downlink MAP IE includes the basic CID of the PSS 100 receiving the resources, the traffic measuring device 110 determines whether there is an RNG-RSP message. In this case, it is required to detect which PSS 100 includes which basic CID to measure the resources allocated to each PSS 100. Accordingly, it is required to receive the RNG-RSP message, determine the MAC address of the PSS 100 and the mapped basic CID, and detect which PSS 100 is mapped to which basic CID.

When there is the RNG-RSP message, the PSS 100 performs the initial access to the RAS 120 to access the network. The PSS 100 receives the RNG-RSP message from the RAS 120 in step S170, and maps and stores the MAC address of the PSS 100 in the message and the basic CID information allocated to the PSS 10 having the corresponding MAC address in step S180.

When the RNG-RSP message is not broadcasted, the basic CID of the PSS 100 stored in the traffic measuring device 110 in step S110 is searched from the basic CID stored in step S180, the MAC address of the PSS 100 mapped to the corresponding basic CID is detected, and the detected MAC address and the corresponding basic CID are mapped and stored in step S190.

After performing the step S190, the traffic measuring device 110 may store the MAC address of the PSS 100 corresponding to the basic CIDs broadcasted through the downlink MAP IE by the RAS 120. Here, since the MAC address of the PSS 100 performs a role of an identifier for identifying a predetermined PSS 100 among the plurality of PSSs, it is required to store the MAC address.

Subsequently, the traffic measuring device 110 maps the number of downlink slots allocated for each basic CID of each PSS 100 and the AMC level that are stored in step S120 to the values stored in step S190, and stores them in step S200. After performing the step S200, the traffic measuring device 110 may store the size of the downlink resource allocated for each PSS receiving the predetermined basic CID having the predetermined MAC address.

When storing the number of downlink slots and the AMC level in step S200, the traffic measuring device 110 searches the basic CID of the PSS 100 stored in step S140 from the basic CIDs stored in step S180 to store the number of uplink slots and the uplink AMC level allocated to each PSS 100. The MAC address of the PSS mapped to the corresponding basic CID is detected, and the detected MAC address and the corresponding basic CID are mapped and stored in step S210.

After performing the step S210, the traffic measuring device 110 may store the MAC address of the PSS 100 corresponding to the basic CIDs broadcasted from the RAS 120 through the uplink MAP IE. Subsequently, the number of uplink slots and the AMC level allocated to each basic CID of each PSS 100 that are stored in step S150 and the values stored in step S210 are mapped and stored in step S220.

After performing the step S220, the traffic measuring device 110 may store the size of the uplink resource allocated to each PSS receiving the predetermined basic CID having the predetermined MAC address. The amount of traffic for each PSS 100 is calculated in step S230 based on the information stored in steps S200 to S220.

In FIG. 5, a process for measuring the traffic in one transmission frame is illustrated, and the traffic measuring device 110 performs the process for each transmission frame. That is, the steps S100 to S230 are performed for each frame of the portable Internet system.

As described above, the amount of traffic used by the PSS 100 may be measured by analyzing the number of slots and the AMC level allocated by the RAS 120 in the transmission frames used when the corresponding PSS 100 is accessed to the RAS 120. When the above method is performed for the PSSs 100 accessed to the RAS 120, the entire traffic amount used for each PSS 100 may be measured.

According to the exemplary embodiment of the present invention, the amount of traffic used in a subscriber station for each subscriber may be measured and analyzed without changing a configuration of the mobile communication system.

In addition, since the traffic measuring device used to measure and analyze the amount of traffic has a simplified configuration, any base station may use the traffic measuring device.

Further, the amount of traffic of the subscriber station using a borrowed network may be measured and analyzed.

The above-described methods and apparatuses are not only realized by the exemplary embodiment of the present invention, but, on the contrary, are intended to be realized by a program for realizing functions corresponding to the configuration of the exemplary embodiment of the present invention or a recording medium for recording the program.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method for measuring an amount of traffic of a subscriber station within an area of a base station including a traffic measuring device in a mobile communication system, the method comprising:
measuring downlink resource size information for each basic connection identifier (CID) based on downlink MAP information elements of a transmission frame broadcasted from the base station;
measuring uplink resource size information for each basic CID based on uplink MAP information elements of the transmission frame broadcasted from the base station; and
measuring the amount of traffic used by the subscriber station having the predetermined basic CID based on the downlink and uplink resource size information.

2. The method of claim 1, wherein the downlink resource size information is first basic CID information comprising the number of downlink slots corresponding to the predetermined basic CID and respective adaptive modulation and coding (AMC) levels of the downlink slots, and the uplink resource size information is second basic CID information comprising the number of uplink slots corresponding to the predetermined basic CID and respective AMC levels of the uplink slots.

3. The method of claim 1, further comprising:
determining whether a ranging response message responding to a ranging request of the subscriber station including a predetermined medium access control (MAC) address is broadcasted from the base station, the ranging response message including the basic CID allocated to the MAC address;
receiving the ranging response message and extracting the MAC address and the basic CID of the subscriber station from the ranging response message when the ranging response message is broadcasted; and
mapping and storing the MAC address and the basic CID.

4. The method of claim 3, wherein the measuring of the amount of traffic comprises:
identifying the basic CID allocated to the subscriber station including the predetermined MAC address from the ranging response message;
searching the downlink and uplink resource size information based on the identified basic CID, and detecting downlink and uplink resource sizes allocated to the subscriber station including the basic CID; and
measuring the amount of traffic of the subscriber station including the basic CID based on the detected downlink and uplink resource sizes.

5. The method of claim 1, further comprising, when a ranging response message is not broadcasted:
mapping the first basic CID information generated in the measuring and the storing of the downlink resource size information and the MAC address of the subscriber station stored in the mapping and storing of the MAC address and the basic CID, and storing mapping information; and
mapping the second basic CID information generated in the measuring and storing of the uplink resource size information and the MAC address of the subscriber station stored in the mapping and storing of the MAC address and the basic CID, and storing the mapping information.

6. The method of claim 3, further comprising, before the measuring and storing of the downlink resource size information:
receiving a downlink frame broadcasted from the base station; and
storing the MAC address of the subscriber station included in burst information of the received downlink frame and the basic CID information allocated to the MAC address.

7. A device for measuring an amount of traffic of a subscriber station within an area of a base station in a mobile communication system, the device comprising:
a MAP information element storage unit for receiving a downlink broadcasted from the base station and storing information elements for downlink and uplink MAPs that are broadcast information included in the downlink;
a downlink/uplink basic connection identifier (CID) information storage unit for storing predetermined basic CID information based on the stored downlink and uplink MAP information elements, the basic CID information including the number of downlink/uplink slots allocated to a basic CID and adaptive modulation and coding (AMC) levels of the downlink/uplink slots;
a downlink/uplink basic CID and MAC address mapping/storing unit for mapping and storing the basic CID information and a medium access control (MAC) address of the subscriber station that is extracted based on a ranging response message broadcasted through burst information included in the downlink broadcasted from the base station;
a ranging response message determining/receiving unit for determining whether there is an initial ranging response message transmitted from the base station, and receiving the initial ranging response message when there is the initial ranging response message transmitted from the base station; and
a traffic calculator for calculating the amount of traffic of the subscriber station based on information stored in the downlink/uplink basic CID and MAC address mapping/storing unit.

8. The method of claim 7, wherein the downlink/uplink basic CID and MAC address mapping/storing unit uses the MAC address of the subscriber station included in the initial ranging response message received from the ranging response message determining/receiving unit to map downlink/uplink basic CIDs.
